(19) United States
(12) Patent Application Publication
(10) Pub. No.: US 2024/0183540 A1
(43) Pub. Date: Jun. 6, 2024

(54) PUSH-IN CATALYST ASSEMBLY FOR A HOME COOKING APPLIANCE

(71) Applicants: BSH Home Appliances Corporation, Irvine, CA (US); BSH Hausgeräte GmbH, Munich (DE)

(72) Inventors: Norman Sewell, New Bern, NC (US); John Gibson, Pollocksville, NC (US)

(21) Appl. No.: 18/073,611

(22) Filed: Dec. 2, 2022

(51) Int. Cl. F24C 15/08; F16B 2/24

(52) U.S. Cl. CPC F24C 15/08; F16B 2/243

(57) ABSTRACT

A push-in catalyst assembly for a home cooking appliance, and a home cooking appliance having a push-in catalyst assembly, are provided. The push-in catalyst assembly includes a body configured to support a catalytic material, the body having a distal end and a proximal end, a flange extending from a region of the proximal end of the body and configured to abut an inner surface of a wall of the cooking compartment, and a plurality of locking spring tabs extending outward from the body. The locking spring tabs have an end portion spaced from the flange by a predetermined distance. The flange and the end portion of each of the locking spring tabs are configured to secure the wall of the cooking compartment therebetween without a fastener.

### FIELD OF THE INVENTION

The present invention is directed to a push-in catalyst assembly for a home cooking appliance, and to a home cooking appliance having such a push-in catalyst assembly, and more particularly, to a push-in catalyst assembly for a home cooking appliance that does not require screws or other fasteners to be secured to the oven wall and can self-tighten itself to the oven wall.

### BACKGROUND OF THE INVENTION

A conventional home cooking appliance, such as a gas oven, electric oven, steam oven, etc., includes a cooking chamber defined by walls and able to be closed by a door of the cooking appliance. During operation of the cooking appliance, fumes and/or odors may be present in the cooking chamber due to foodstuff, residue, debris, cooking utensils, etc. being subjected to heating or cooking processes. Similarly, fumes and/or odors may be present in the cooking chamber during a self-cleaning cycle. In order to reduce or minimize such fumes or odors within the cooking chamber, or from vapor streams escaping from or being exhausted from the cooking chamber into the surrounding environment, some conventional home cooking appliances may include one or more catalyst devices or catalyst assemblies having a catalyst, such as a plurality of catalytically active elements and/or a catalytically active surface coating or coatings.

### SUMMARY OF THE INVENTION

The present invention recognizes that designs for conventional catalyst assemblies that require the assembly to be inserted through an opening in a wall of a cooking compartment and coupled to the wall with one or more screws or other fasteners can be complex and time-consuming to install. For example, as shown in FIG. 16, an example of a conventional catalyst assembly 300 can include a flange 302 having one or more openings 304 for receiving one or more screws or other fasteners 306. The conventional catalyst assembly 300 may be inserted through an opening 315 in a wall 314 of a cooking compartment 320 and coupled to the wall 314 with one or more screws or other fasteners 306 inserted through openings 304 and into corresponding openings 316 in the wall 314 of the cooking compartment. The present invention recognizes that one or more production steps may be necessary to prepare the wall of the cooking compartment to receive the catalyst assembly along with the screws or other fasteners, such as a plurality of openings in the wall, threaded openings, etc. Similarly, one or more production steps may be necessary to prepare the catalyst assembly to receive the screws or other fasteners, such as a plurality of openings, threaded openings, etc. in a flange of the catalyst assembly. In some instances, additional components may be required to secure the fasteners in place, such as one or more nuts or locking nuts. Even in instances in which a self-drilling or self-tapping fastener may be used, during assembly, an installer may need to handle and position the screws or other fasteners in place and use a tool to secure the screws or other fasteners through the catalyst assembly and into the wall of the cooking compartment, which can complicate the assembly process and increase the amount of time required to install the catalyst assembly to the wall of the cooking compartment. This may be particularly complex or time-consuming in instances in which an installer will need to reach into the cooking compartment and install the catalyst assembly and its corresponding fasteners into a difficult to reach and/or difficult to see position within the cooking compartment, such as an upper wall, rear wall, or rear end of a sidewall of the cooking compartment or other hard to reach and/or hard to see locations such as a location of a wall adjacent to a corner of the cooking compartment.

Additionally, the present invention recognizes that it may be difficult or time consuming to avoid gaps between the catalyst assembly and the wall of the cooking compartment with conventional designs. For example, in the conventional catalyst assembly 300, the screws or fasteners may need to be tightened, and more particularly, evenly tightened, by a suitable amount to avoid gaps between the catalyst assembly and the wall of the cooking compartment, which may undesirably affect the functionality and/or appearance of the catalyst assembly.

These problems and others are addressed by the present invention, a first exemplary embodiment of which comprises a push-in catalyst assembly for a home cooking appliance, the push-in catalyst assembly comprising a body configured to support a catalytic material, the body having a distal end and a proximal end, a flange extending from a region of the proximal end of the body and configured to abut an inner surface of a wall of the cooking compartment, a plurality of locking spring tabs extending outward from the body, the plurality of locking spring tabs having an end portion spaced from the flange by a predetermined distance, wherein the flange and the end portion of each of the plurality of locking spring tabs are configured to secure the wall of the cooking compartment therebetween without a fastener. In this way, the present invention can provide a push-in catalyst assembly for a home cooking appliance, and more particularly, a push-in catalyst assembly for a home cooking appliance that does not require screws or other fasteners to be secured to the oven wall, and in some examples, that can self-tighten itself to the oven wall, thereby simplifying the manufacturing process and minimizing or eliminating undesirable gaps between the catalyst assembly and the wall of the cooking compartment, while improving the functionality and/or appearance of the catalyst assembly.

In an example, each of the plurality of locking spring tabs can be biased to extend outward from an outermost perimeter of the body. In an example, each of the plurality of locking spring tabs can be configured to flex in an inward direction with respect to the body and to resist flexing in an outward direction beyond a predetermined biased position with respect to the body. A locking spring tab of the plurality of locking spring tabs can include a flap projecting from the body and biased to extend outward from an outermost perimeter of the body. In an example, the plurality of locking spring tabs can be spaced around a perimeter of the body, and in some examples, equally spaced around the perimeter of the body. A locking spring tab of the plurality of locking spring tabs can have a fixed end coupled to the body and a free end extending from the body. A locking spring tab of the plurality of locking spring tabs can have, for example, a triangular profile, a U-shaped profile, a square-shaped profile, etc. In an example, the end portion of the locking spring tab can include a cam surface facing the flange, wherein a part of the cam surface is spaced from the flange by the predetermined distance. Additionally or alternatively, an edge of the end portion which faces in an outward direction with respect to the body can include at least one of an angled profile and a curved profile. In an example, the flange has a fixed position with respect to the body. The predetermined distance that the end portion is spaced from the flange can be configured to be substantially equal to a thickness of the wall of the cooking compartment.

Another exemplary embodiment of the invention comprises a household appliance having a push-in catalyst assembly according to the examples of the present invention. The household appliance can include a housing having a cooking compartment, the cooking compartment defined at least in part by a wall, the wall having an inner surface facing the cooking compartment, an outer surface facing outside the cooking compartment, and an opening, and a push-in catalyst assembly disposed in the opening and secured to the wall of the cooking compartment, wherein the push-in catalyst assembly can include a body configured to support a catalytic material, the body having a distal end and a proximal end, wherein the body extends through the opening in the wall such that the distal end is disposed on an outer side of the wall with respect to the cooking compartment, a flange extending from a region of the proximal end of the body and configured to abut the inner surface of the wall facing the cooking compartment, the flange having a diameter greater than a diameter of the opening, and a plurality of locking spring tabs extending outward from the body and disposed between the flange and the proximal end of the body, wherein the plurality of locking spring tabs is disposed on the outer side of the wall with respect to the cooking compartment, wherein each of the plurality of locking spring tabs can include an end portion spaced from the flange by a predetermined distance, and wherein the flange and the end portion of each of the plurality of locking spring tabs are configured to secure the wall of the cooking compartment therebetween without a fastener. In this way, the present invention can provide a home cooking appliance having a push-in catalyst assembly that does not require screws or other fasteners to be secured to the oven wall, and in some examples, can self-tighten itself to the oven wall, thereby simplifying the manufacturing process and minimizing or eliminating undesirable gaps between the catalyst assembly and the wall of the cooking compartment, while improving the functionality and/or appearance of the catalyst assembly.

In some examples, each of the plurality of locking spring tabs can be biased to extend radially outward from an outermost perimeter of the body such that the plurality of locking spring tabs can extend beyond the diameter of the opening. Each of the plurality of locking spring tabs can be configured to flex in an inward direction with respect to the body of the push-in catalyst assembly when the push-in catalyst assembly is pushed into the opening such that the plurality of locking spring tabs can be capable of passing through the opening along with the body of the push-in catalyst assembly. The plurality of locking spring tabs can restrict a removal of the push-in catalyst assembly from the opening when the push-in catalyst assembly is in an installed position within the opening. In an example, a locking spring tab of the plurality of locking spring tabs has a fixed end coupled to the body and a free end extending from the body. A part of the free end of the locking spring tab of the plurality of locking spring tabs can abut the outer surface of the wall of the cooking compartment when the push-in catalyst assembly is in an installed position within the opening. In an example, the part of the free end of the locking spring tab can exert a force on the outer surface of the wall of the cooking compartment when the push-in catalyst assembly is in an installed position within the opening to thereby draw the flange in a direction toward the inner surface of the wall of the cooking compartment. The flange can abut an interior surface of the wall of the cooking compartment when the push-in catalyst assembly is in the installed position within the opening. In an example, the free end of the locking spring tab can include a cam surface facing the flange, wherein a part of the cam surface is spaced from the flange by the predetermined distance. Additionally or alternatively, an edge of the free end of the locking spring tab which faces in an outward direction with respect to the body can include at least one of an angled profile and a curved profile.

Yet another exemplary embodiment of the invention comprises a household appliance having a push-in catalyst assembly according to the examples of the present invention. The household appliance can include a housing having a cooking compartment, the cooking compartment defined at least in part by a wall, the wall having an inner surface facing the cooking compartment, an outer surface facing outside the cooking compartment, and an opening, and a push-in catalyst assembly disposed in the opening and secured to the wall of the cooking compartment, wherein the push-in catalyst assembly can include a body configured to support a catalytic material, the body having a distal end and a proximal end, wherein the body extends through the opening in the wall such that the distal end is disposed on an outer side of the wall with respect to the cooking compartment, a flange extending from a region of the proximal end of the body and configured to abut the inner surface of the wall facing the cooking compartment, the flange having a diameter greater than a diameter of the opening, and locking means for securing and tightening the flange against the wall of the cooking compartment without a fastener. In this way, the present invention can provide a home cooking appliance having a push-in catalyst assembly that does not require screws or other fasteners to be secured to the oven wall, and in some examples, can self-tighten itself to the oven wall, thereby simplifying the manufacturing process and minimizing or eliminating undesirable gaps between the catalyst assembly and the wall of the cooking compartment, while improving the functionality and/or appearance of the catalyst assembly.

For purposes of this disclosure, a “catalyst assembly” is intended to be understood, in particular, to be a device configured to support a catalytic material, such as a device configured to contain or receive a catalytic material and/or to be coated with a catalytic material.

Other features and advantages of the present invention will become apparent to those skilled in the art upon review of the following detailed description and drawings.

### BRIEF DESCRIPTION OF THE DRAWINGS

These and other aspects and features of embodiments of the present invention will be better understood after a reading of the following detailed description, together with the attached drawings, wherein:

FIG. 1 is a perspective view of a push-in catalyst assembly for a home cooking appliance according to an exemplary embodiment of the invention;

FIG. 2 is a front view of a home cooking appliance having a push-in catalyst assembly according to an exemplary embodiment of the invention;

FIG. 3 is a side, cut-away view of a home cooking appliance having a push-in catalyst assembly according to an exemplary embodiment of the invention;

FIG. 4 is a partial, perspective view of a home cooking appliance having a push-in catalyst assembly according to an exemplary embodiment of the invention;

FIG. 5A is a side view of a push-in catalyst assembly according to an exemplary embodiment of the invention;

FIG. 5B is a partial side view of a wall of a cooking compartment of a home cooking appliance having a push-in catalyst assembly according to an exemplary embodiment of the invention;

FIG. 6A is a partial, cross-sectional view of a push-in catalyst assembly according to an exemplary embodiment of the invention;

FIG. 6B is a partial, cross-sectional view of a wall of a cooking compartment of a home cooking appliance having a push-in catalyst assembly according to an exemplary embodiment of the invention;

FIG. 7 is a top view of a push-in catalyst assembly for a home cooking appliance according to an exemplary embodiment of the invention;

FIG. 8 is a perspective view of a push-in catalyst assembly for a home cooking appliance according to another exemplary embodiment of the invention;

FIG. 9A is a side view of a push-in catalyst assembly according to another exemplary embodiment of the invention;

FIG. 9B is a partial side view of a wall of a cooking compartment of a home cooking appliance having a push-in catalyst assembly according to another exemplary embodiment of the invention;

FIG. 10A is a partial, cross-sectional view of a push-in catalyst assembly according to another exemplary embodiment of the invention;

FIG. 10B is a partial, cross-sectional view of a wall of a cooking compartment of a home cooking appliance having a push-in catalyst assembly according to another exemplary embodiment of the invention;

FIG. 11 is a top view of a push-in catalyst assembly for a home cooking appliance according to another exemplary embodiment of the invention;

FIG. 12 is a partial, perspective view of a locking spring tab of a push-in catalyst assembly according to an exemplary embodiment of the invention;

FIGS. 13A-13D are front and side views of a locking spring tab of a push-in catalyst assembly according to exemplary embodiments of the invention;

FIG. 14 is a partial, perspective view of a locking spring tab of a push-in catalyst assembly according to another exemplary embodiment of the invention;

FIGS. 15A-15D are front and side views of a locking spring tab of a push-in catalyst assembly according to exemplary embodiments of the invention; and

FIG. 16 is a partial, perspective view of a conventional home cooking appliance and a conventional catalyst assembly.

### DETAILED DESCRIPTION OF THE EXEMPLARY EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

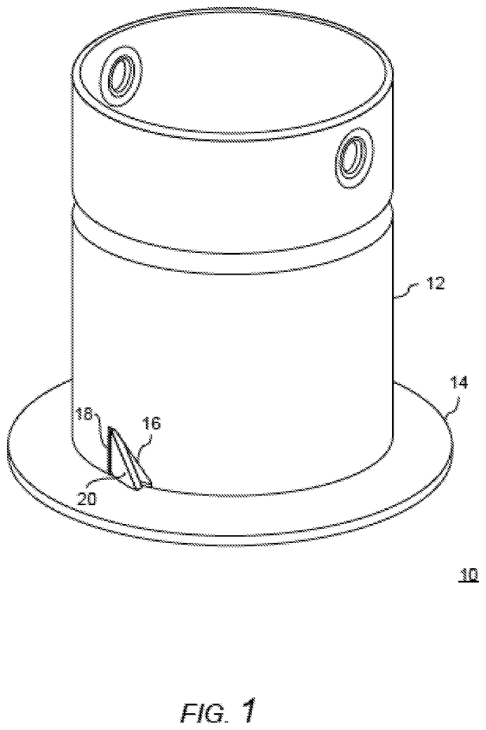

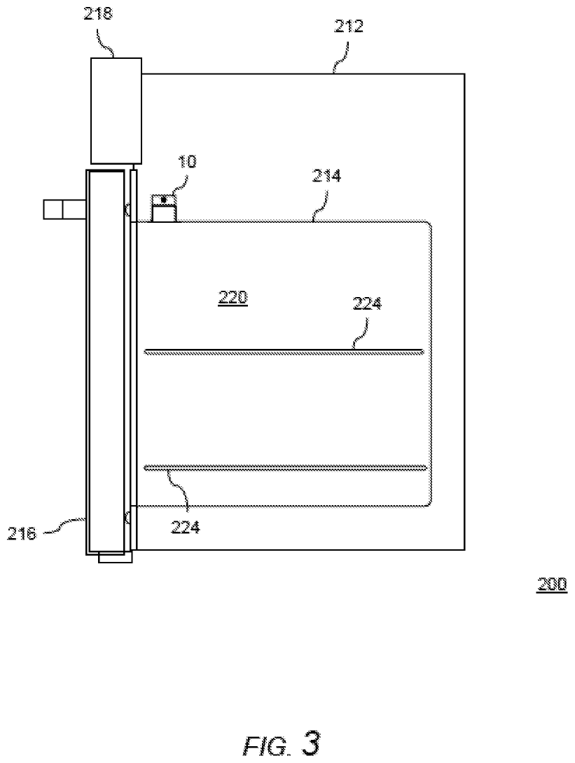

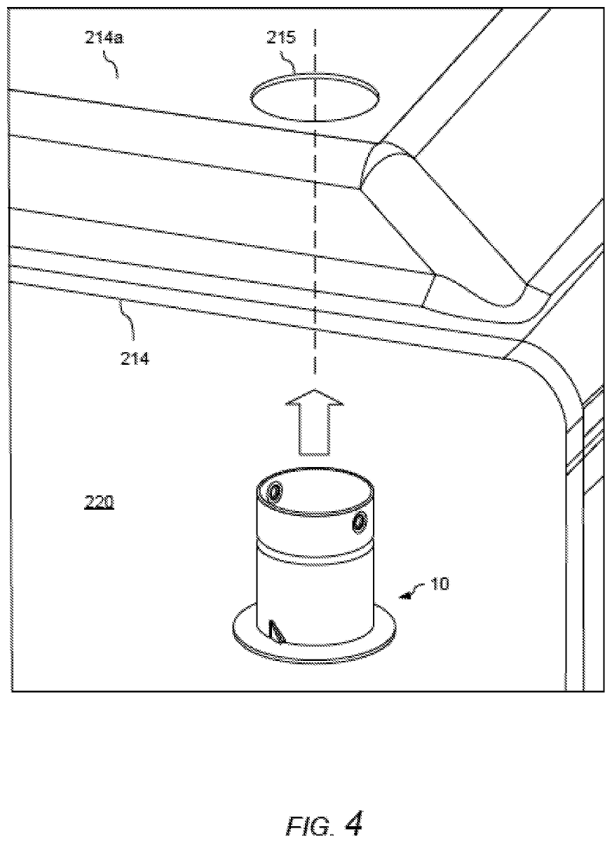

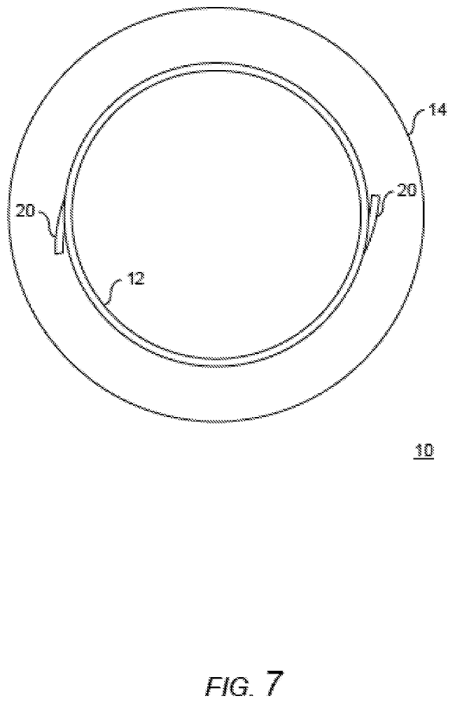

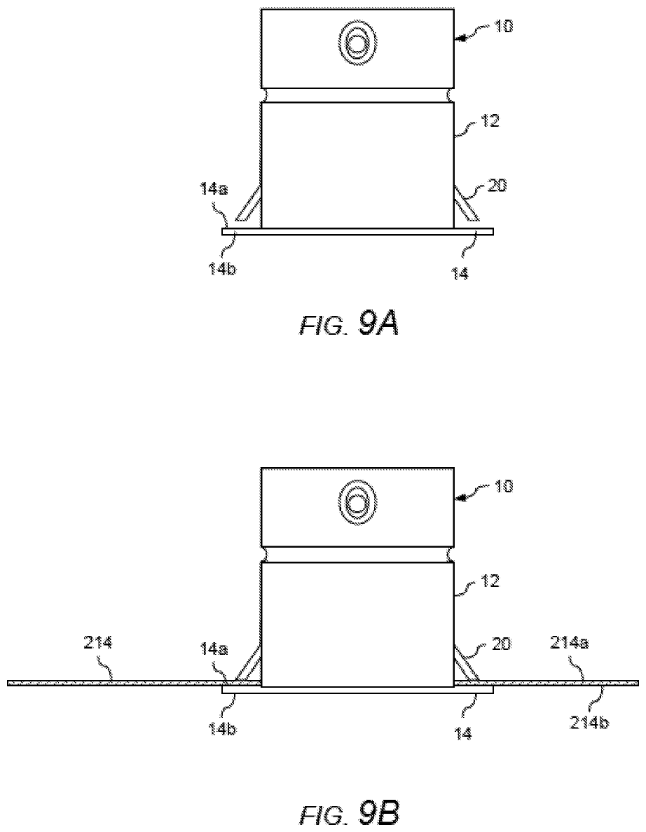

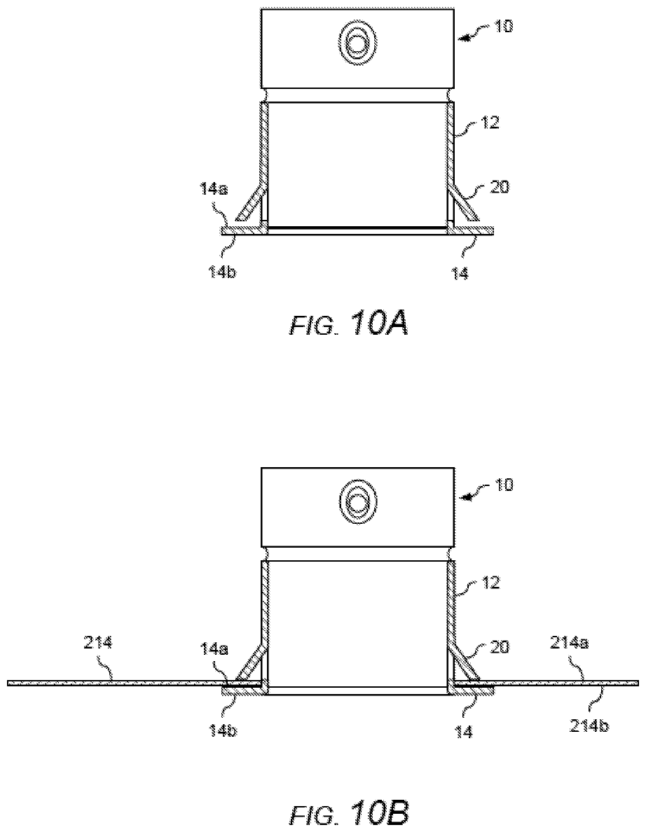

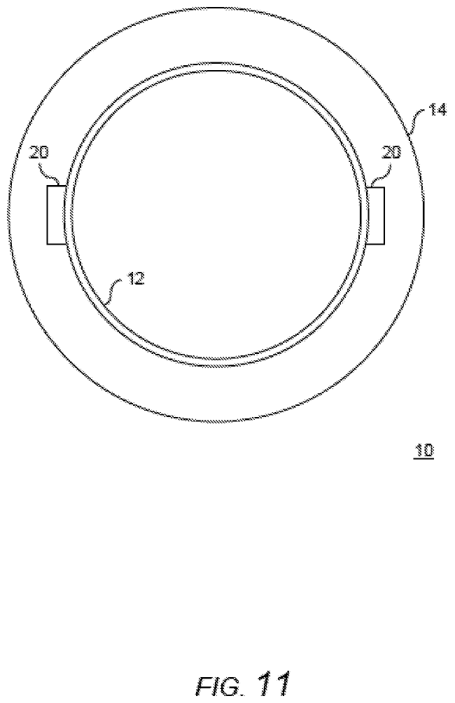

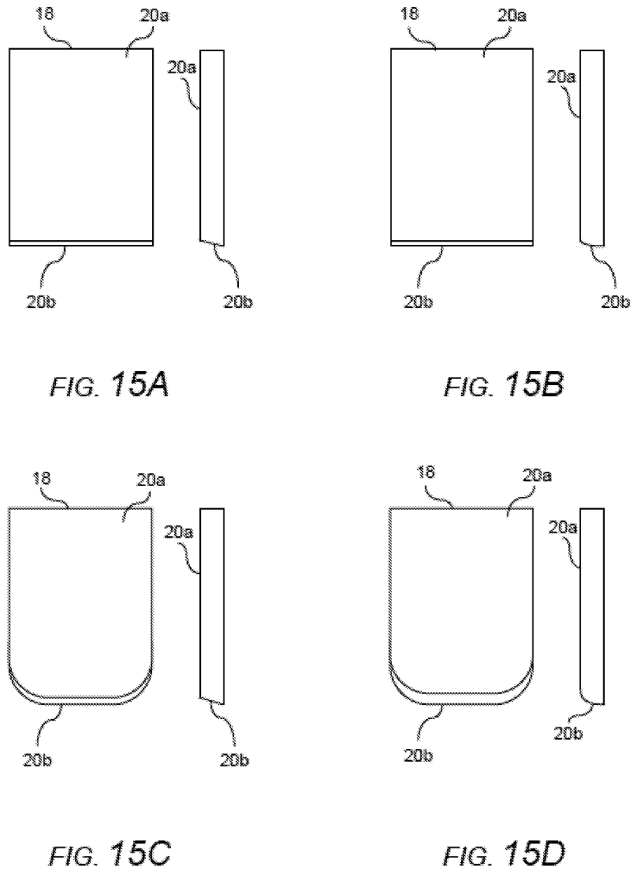

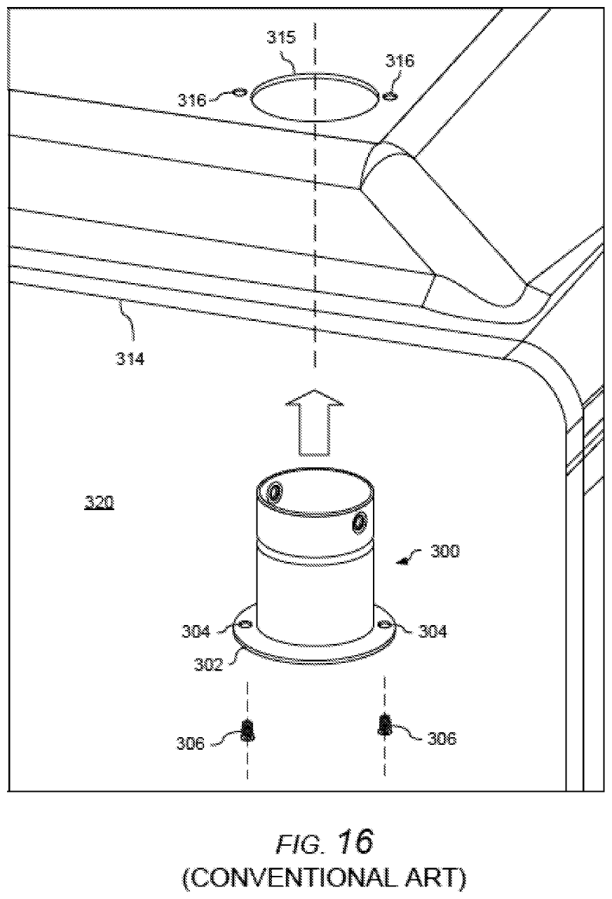

Referring now to FIGS. 1-15D, exemplary embodiments of a push-in catalyst assembly for a home cooking appliance, and a home cooking appliance having a push-in catalyst assembly, will now be described.

As shown in FIG. 1, an example of push-in catalyst assembly 10 for a home cooking appliance can include a body 12 configured to support a catalytic material. For example, the body 12, can be configured to contain or receive a catalytic material therein and/or to be coated with a catalytic material, etc. The push-in catalyst assembly 10 can include a flange 14 extending from a part of the body 12, such as an end of the body 12. The push-in catalyst assembly 10 can include a plurality of locking spring tabs 20 extending from a part of the body 12, for example, from a part of the body 12 that is adjacent to (e.g., directly adjacent to) the flange 14. Example features of a push-in catalyst assembly 10 will be described in greater detail below.

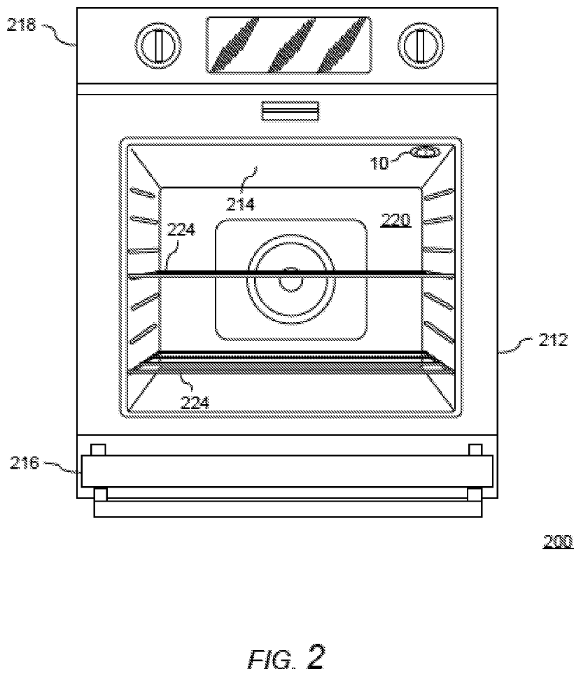

With reference to FIGS. 2-4, an example of a home cooking appliance 200 having a push-in catalyst assembly 10 will now be described. The home cooking appliance 200 can include a housing 212 having a cooking compartment 220 formed by one or more walls 214 and being accessible via a door 216. The cooking compartment 220 can include one or more racks 224 for receiving and supporting foodstuff and/or cookware. The home cooking appliance 200 according to the invention can include, for example, a standalone appliance, wall mounted appliance, such as a stand-alone oven, wall mounted oven, double oven, combination oven, countertop oven, microwave oven, air fryer, or a freestanding range having one or more gas or electric cooking or warming devices, such as an oven, steam oven, convection oven, and/or warming drawer. One of ordinary skill will recognize that other configurations are possible. The home cooking appliance 200 can include a control panel 218 having one or more user input devices, such as one or more control knobs, touch sensitive input devices, etc., for controlling operation of one or more gas or electric heating elements, circulating fans, etc. in the cooking compartment 220 for performing a preheat operation, cooking operation, warming operation, etc. The home cooking appliance 200 can include a controller or control unit comprising, for example, a processor or computation unit, a memory unit, and an operating program which is stored in the memory unit and executed by the processor or computation unit. The control unit can be provided for controlling one or more cooking processes, controlling one or more operations or functions of various components of the appliance 200, among other things.

As shown in FIGS. 2-4, a home cooking appliance 200 according to the examples of the present invention can include a push-in catalyst assembly 10 secured in a wall 214 of the cooking compartment 220, such as a top wall of the cooking compartment. In other examples, the push-in catalyst assembly 10 can be secured in a different location of the wall 214, or in another wall of the cooking compartment 220, such as a back wall, side wall, or bottom wall. In the illustrated example, the push-in catalyst assembly 10 can be inserted from within the cooking compartment 220 into an opening 215 formed in the wall 214 of the cooking compartment 220 such that the push-in catalyst assembly 10 is inserted into the opening 215 in a direction extending from within the cooking compartment 220 through the opening 215 toward an exterior of the cooking compartment 220. The exemplary push-in catalyst assembly 10 does not require screws or other fasteners to be secured to the oven wall 214, and particularly to be secured in the opening 215 of the oven wall 214, and can be configured to self-tighten itself to the oven wall 214. Example features of a push-in catalyst assembly 10, and a home cooking appliance 200 having a push-in catalyst assembly 10, will be described in greater detail below.

With reference to the examples illustrated in FIGS. 1 and 5A-7 and FIGS. 8-11, examples of a push-in catalyst assembly 10 for a home cooking appliance can include a body 12 configured to contain or receive a catalytic material and/or to be coated with a catalytic material, etc. The body 12 can include a distal end configured to be inserted into the opening 215 in a direction extending from within the cooking compartment 220 through the opening 215 toward an exterior of the cooking compartment 220. The body 12 can include a proximal end configured to be adjacent to, or secured to, the wall 214 forming the cooking compartment 220.

In the illustrated examples, the push-in catalyst assembly 10 can include a flange 14 extending from a part of the body 12, such as at or adjacent to the proximal end of the body 12. In the illustrated examples, the body 12 (e.g., a longitudinal extent thereof) is formed in the shape of a cylinder. However, in other examples, the body 12 can have other shapes, such as a square, rectangular, oval, or another shape configured to correspond to a shape of an opening 215 in a wall 214 of the cooking compartment 220. The body 12 can have a size and shape corresponding to a size and shape of the opening 215 in the wall 214 such that the body 12 can pass through the opening 215. The body 12 can be a hallow body with one or more open ends, or the body can be closed at one or more ends, perforated at one or more ends, etc. In an example, the body 12 of the push-in catalyst assembly 10 can be configured to support a catalytic material, such as configured to contain or receive a catalytic material and/or to be coated with a catalytic material.

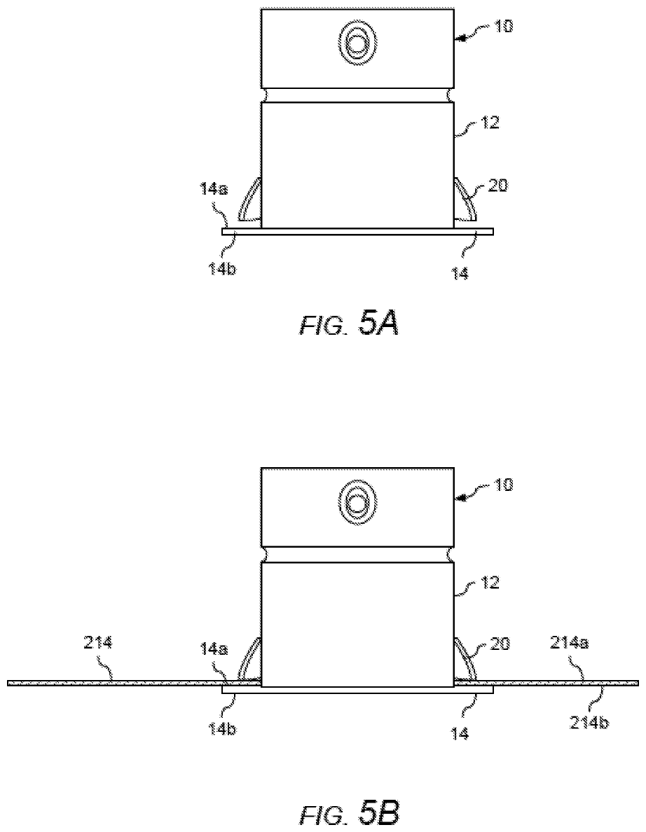

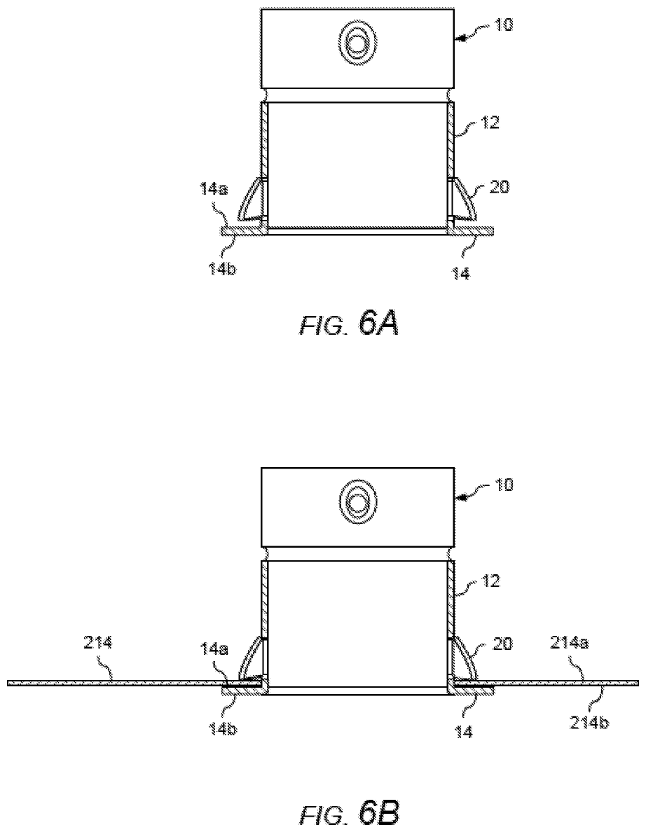

As shown particularly in the example of FIGS. 5B and 6B, the flange 14 can be configured to abut a surface 214b of a wall 214 that faces the interior of the cooking compartment 220. The flange 214 can prevent the entirety of the push-in catalyst assembly 10 from passing completely through the opening 215 in the wall 214. A diameter or width of the flange 14 can be configured to be greater than a diameter or width of the opening 215 in the wall 214. In the illustrated example, the flange 14 has a circular shape. However, in other examples, the flange 14 can have other shapes, such as a square, rectangular, or another shape. In some examples, the flange 14 can have a shape that is the same as, or similar to, a shape of the opening 215 and/or to a shape of the body 12. For example, both the flange 14 and the opening 215 can have a circular shape. In other examples, the flange 14 can have a shape that is different from a shape of the opening 215 and/or a shape of the body 12. For example, the flange 14 can have a square shape, while the body 12 and the opening 215 can have a circular shape, cylindrical shape, etc.

In the illustrated examples, the flange 14 can have a fixed position with respect to the body 12. The flange 14 can be rigid or configured to resist flexing. In an example, the flange 14 can be continuous around the entire perimeter of the body 12. That is, the flange 14 can be devoid of any notches, gaps, openings such as screw holes, etc. The flange 14 can have an upper surface 14a. In an example, at least a portion of the upper surface 14a can be configured to abut an inner surface 214b of the wall 214 around an entire circumference of the opening 215 in the wall 214. The flange 214 can have a continuous lower surface 14b configured to face an interior of the cooking compartment 220.

As shown in the examples illustrated in FIGS. 1 and 5A-7 and FIGS. 8-11, the push-in catalyst assembly 10 can include a plurality of locking spring tabs 20 having at least a portion projecting in a direction outward (e.g., radially outward) from the body 12. In the illustrated examples, the push-in catalyst assembly 10 includes a pair of locking spring tabs 20 being disposed on opposite sides of the body 12. In other examples, the locking spring tabs 20 can disposed at different positions around the body 12. In still other examples, different numbers of tabs 20 can be provided at different positions or spacings around the body 12. The tabs 20 can be equally spaced around a perimeter of the body 12 or have different spacing around the perimeter between at least two of the tabs 20.

The plurality of locking spring tabs 20 can be configured to be resilient or flexible such that each of the tabs 20 can move or flex (e.g., radially inward) by a sufficient amount relative to the body 12 to allow both the body 12 and locking spring tabs 20 of the push-in catalyst assembly 10 to pass through the opening 215 in the wall 214 as the push-in catalyst assembly 20 moves through the opening 215. In an example, a portion of each of the locking spring tabs 20 facing toward the distal end of the body 12 (i.e., in the direction of insertion during the process of inserting into the opening 215) can be angled, tapered, and/or curved to promote the movement or flexing (e.g., radially inward flexing) of the tabs 20 relative to the body 12 as the tabs 20 contact the wall 214 around the opening 215 and the body 12 and tabs 20 are pushed through the opening 215.

The locking spring tabs 20 can be configured to be biased outward (e.g., biased radially outward) such that the locking spring tabs 20 move or spring back toward their original, outward extending positions after the locking spring tabs 20 pass through the opening 215 in the wall 214. As shown in the example illustrated in FIGS. 5B and 6B, when the push-in catalyst assembly 10 is completely inserted into the opening 215, the flange 14 of the push-in catalyst assembly 10 is disposed on an inner side of the wall 214 facing the cooking compartment 220 and a surface 14a of the flange 14 abuts an inner surface 214b of the wall 214 that faces the interior of the cooking compartment 220. Furthermore, when the push-in catalyst assembly 10 is completely inserted into the opening 215, the plurality of locking spring tabs 20 of the push-in catalyst assembly 10 are disposed on an outer side of the wall 214 facing away from the cooking compartment 220.

When the push-in catalyst assembly 10 is completely inserted into the opening 215, a portion of each of the locking spring tabs 20 can be configured to abut or engage an outer surface 214a (i.e., a surface facing the exterior of the cooking compartment 220) of the wall 214, to thereby secure the wall 214 between the locking spring tabs 20, on one side (i.e., the outer side) of the wall 214, and the flange 14, on the other side (i.e., the inner side) of the wall 214. In this way, the push-in catalyst assembly 10 can be simply and reliably secured in the opening 215 of the wall 214 without screws or other fasteners being required.

In an example, the locking spring tabs 20 can be configured such that, when the locking spring tabs 20 are in an extended (e.g., neutral or resting) position, an end portion of each of the locking spring tabs 20, which faces the flange 14, is spaced from the flange 14 by a predetermined distance to accommodate a part of the wall 214 therebetween. In an example, the locking spring tabs 20 can be configured such that, when the locking spring tabs 20 are in the extended (e.g., neutral or resting) position, at least a part of the end portion of each of the locking spring tabs 20, which faces the flange 14, is spaced from the flange 14 by a distance that is equal to (e.g., substantially equal to) a thickness of the wall 214, or equal to or less than a thickness of the wall 214.

In another example, the locking spring tabs 20 can be configured such that, when the locking spring tabs 20 are in the extended (e.g., neutral or resting) position, at least a part of the end portion of each of the locking spring tabs 20, which faces the flange 14, is spaced from the flange 14 by a distance that is less than a thickness of the wall 214. In this example, at least a part of the end portion of each locking spring tab 20 can be configured to exert a biasing force on the outer surface 214a of the wall 214 (e.g., a biasing force normal to the wall 214), which can have the effect of biasing the body 12 in the direction of insertion, and which, in turn, can correspondingly bias or draw the upper surface 14a of the flange 14 toward, or tightly against, the inner surface 214b of the wall 214, thereby minimizing or eliminating a gap between the upper surface 14a of the flange 14 and the inner surface 214b of the wall 214.

In an example, an end portion of each locking spring tab 20, or at least a part thereof, can have an angled or curved profile. For example, a leading edge of the end portion of the locking spring tab 20, which faces in a direction outward (e.g., in a direction radially outward), can have an angled or curved profile. As a result, during the assembly process, the angled or curved leading edge can guide the end portion of the tab 20 over an edge of the opening 215 in the wall 214 as the locking spring tab 20 completes the process of passing through the opening 215 in the wall 214. Moreover, during the assembly process, the angled or curved leading edge can guide the end portion of the tab 20 over the outer surface 214a of the wall 214 such that the tab 20 can move or slide over the outer surface 214a of the wall 214, owing to the outward bias of the locking spring tab 20 in a direction toward the original outward extending (e.g., resting) position of the tab 20. Accordingly, in this example, at least a part of the end portion of each locking spring tab 20 can be configured to exert a biasing force on the outer surface 214a of the wall 214 (e.g., normal to the wall 214), which can have the effect of biasing the body 12 in the direction of insertion, which correspondingly biases or draws the upper surface 14a of the flange 14 toward or tightly against the inner surface 214b of the wall 214, thereby minimizing or eliminating a gap between the upper surface 14a of the flange 14 and the inner surface 214b of the wall 214.

With reference again to the examples illustrated in FIGS. 1 and 5A-7 and FIGS. 8-11, the locking spring tabs 20 can be configured to be cut from a surface of the body 12 and angled or curved outward (e.g., radially outward) from the body 12, for example by bending the locking spring tabs 20 outward by a predetermined amount. That is, the locking spring tabs 20 can be bent outward to a predetermined bend angle or bend line. The locking spring tabs 20 can be configured to be angled or curved outward along a predetermined bend angle or bend line such that the tabs 20 are disposed at a predetermined spring resting position with respect to the body 12.

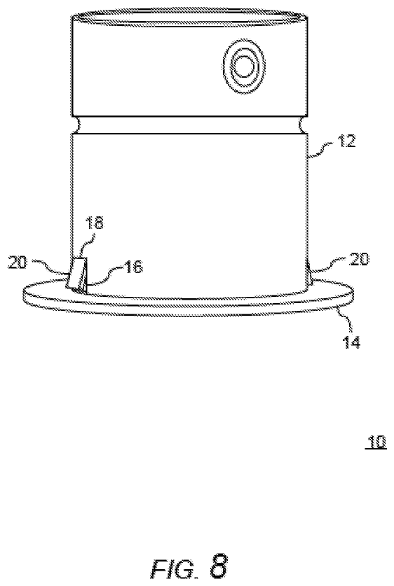

In the example illustrated in FIGS. 1 and 5A-7, each locking spring tab 20 can be formed by cutting a hanging flap from a surface of the body 12 along cut line 16 and bending, angling, or curving the flap outward (e.g., radially outward) from the body 12 about a vertical axis 18 (e.g., a vertical hinge similar to a door). On the other hand, in the example illustrated in FIGS. 8-11, each locking spring tab 20 can be formed by cutting a hanging flap from a surface of the body 12 along cut line 16 and bending, angling, or curving the flap outward (e.g., radially outward) from the body 12 about a horizontal axis 18 (e.g., a horizontal hinge). In each of the examples, the locking spring tabs 20 can be configured to be angled or curved outward along a predetermined bend angle or line such that the tabs 20 are disposed at a predetermined spring resting position with respect to the body 12. One of ordinary skill in the art will recognize that other arrangements are contemplated, such as one or more tabs 20 being hinged at an angle other than vertical or horizontal, such as at a 45° angle or another angle.

With reference again to the examples illustrated in FIGS. 1 and 5A-7 and FIGS. 8-11, each locking spring tab 20 can be formed by a hanging flap having a shape configured to promote the movement or flexing (e.g., radially inward flexing) of the tabs 20 relative to the body as the tabs 20 contact the wall 214 around the opening 215 and the body 12 and tabs 20 are pushed through the opening 215.

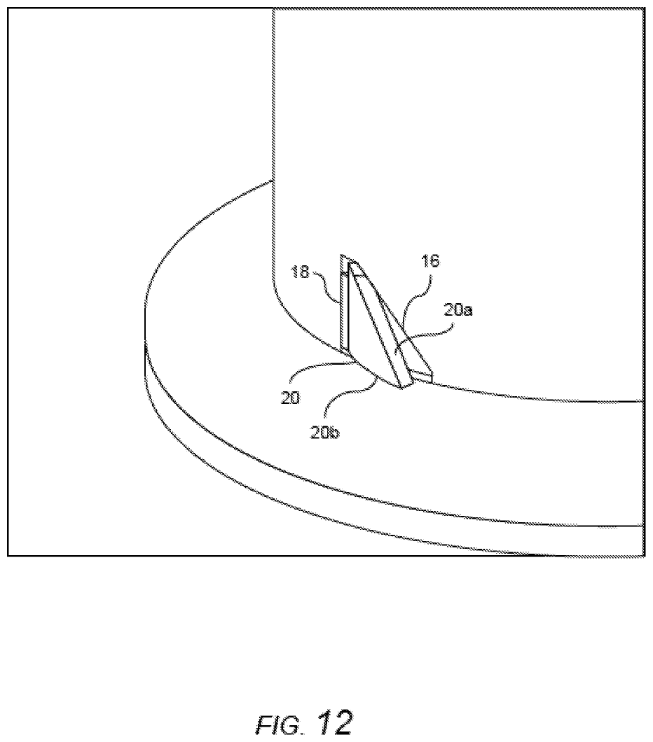

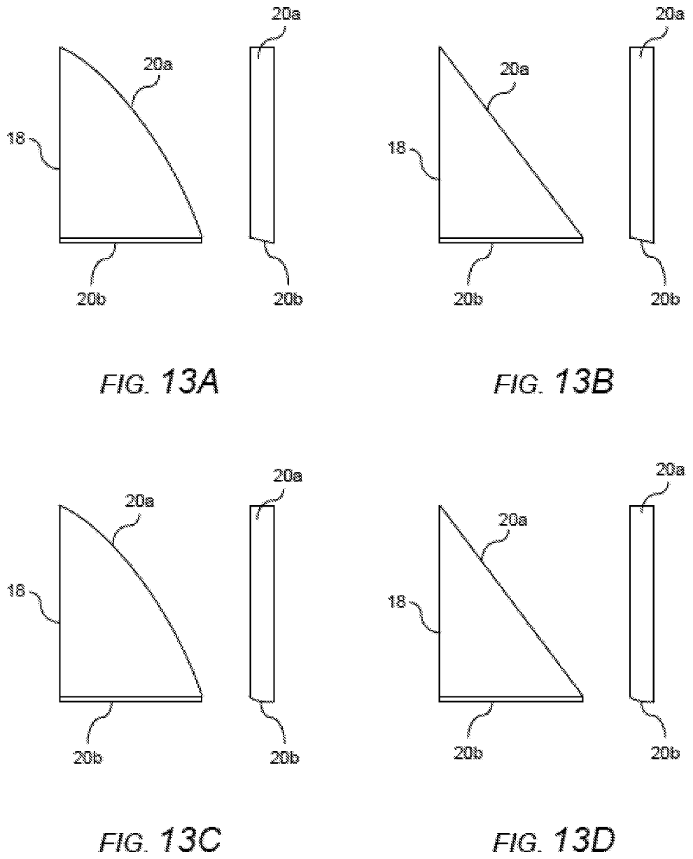

FIG. 12 shows an enlargement of a side-hinged, locking spring tab 20 similar to the examples illustrated in FIGS. 1 and 5A-7. In this example, the locking spring tab 20 can include one or more cam surfaces (e.g., surface 20a) facing toward the distal end of the body 12 (i.e., in the direction of insertion during the process of inserting into the opening 215) that are angled, tapered, and/or curved to promote the movement or flexing (e.g., radially inward flexing) of the tabs 20 relative to the body 12 as the tabs 20 contact the wall 214 around the opening 215 and the body 12 and tabs 20 pass through the opening 215. Additionally or alternatively, the locking spring tab 20 can include one or more cam surfaces (e.g., surface 20b) that are angled, tapered, and/or curved to guide the end portion of the tab 20 over an edge of the opening 215 in the wall 214 as the locking spring tab 20 completes the process of passing through the opening 215 in the wall 214 and/or such that the cam surface 20b moves or slides over the outer surface 214a of the wall 214, owing to the outward bias of the locking spring tab 20 in a direction toward the original outward extending (e.g., resting) position. In this example, at least a leading edge of the end portion of the locking spring tab 20, which faces in a direction outward (e.g., in a direction radially outward), can have an angled or curved cam surface 20b. The cam surface 20b of the locking spring tab 20 can be configured to exert a biasing force on the outer surface 214a of the wall 214 (e.g., normal to the wall 214). FIGS. 13A-13D illustrate additional example configurations of side-hinged, locking spring tabs 20 having different exemplary arrangements of curved and/or angled cam surfaces 20a and 20b. As shown in the examples, the cam surface can be formed by a planar surface or a curved surface.

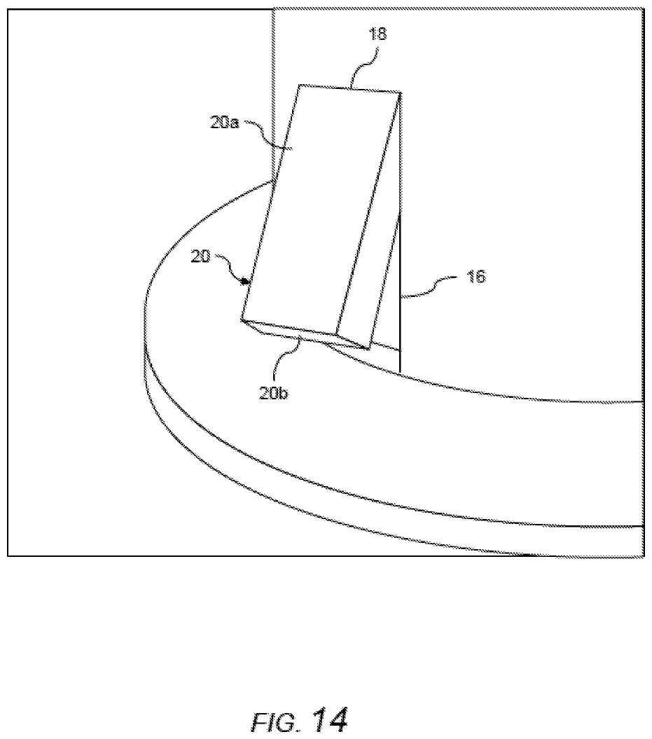

FIG. 14 shows an enlargement of a top-hinged, locking spring tab 20 similar to the examples illustrated in FIGS. 8-11. In this example, the locking spring tab 20 can include one or more cam surfaces (e.g., surface 20a) that are angled, tapered, and/or curved to promote the movement or flexing (e.g., radially inward flexing) of the tabs 20 relative to the body as the tabs 20 contact the wall 214 around the opening 215 and the body 12 and tabs 20 are pushed through the opening 215. Additionally or alternatively, the locking spring tab 20 can include one or more cam surfaces (e.g., surface 20b) that are angled, tapered, and/or curved to guide the end portion of the tab 20 over an edge of the opening 215 in the wall 214 as the locking spring tab 20 completes the process of passing through the opening 215 in the wall 214 and/or to guide the end portion of the tab 20 such that the cam surface 20b moves or slides over the outer surface 214a of the wall 214, owing to the outward bias of the locking spring tab 20 in a direction toward the original outward extending (e.g., resting) position. In this example, the cam surface 20b of the locking spring tab 20 can be configured to exert a biasing force on the outer surface 214a of the wall 214 (e.g., normal to the wall 214). FIGS. 13A-13D illustrate additional example configurations of top-hinged, locking spring tabs 20 having different exemplary arrangements of curved and/or angled cam surfaces 20a and 20b. As shown in the examples, the cam surface can be formed by a planar surface or a curved surface.

In an example of a home cooking appliance having a push-in catalyst assembly according to the examples illustrated in FIGS. 12-15D, the locking spring tabs 20 can be configured such that, when the locking spring tabs 20 are in the extended (e.g., neutral or resting) position, at least a part of the end portion of each of the locking spring tabs 20 that faces the flange 14 is spaced from the flange 14 by a distance that is equal to or less than a thickness of the wall 214. For example, a trailing edge of the cam surface 20b of the locking spring tab 20 can be spaced from the flange 14 by a distance that is substantially equal to a thickness of the wall 214, or in some examples, slightly less than a thickness of the wall 214. As a result, during the assembly process, the cam surface 20b can guide the end portion of the tab 20 over an edge of the opening 215 in the wall 214 as the locking spring tab 20 completes the process of passing through the opening 215 in the wall 214 and then continue to guide the end portion of the tab 20 over the outer surface 214a of the wall 214 until the locking spring tabs 20 are in an extended position, such as a neutral or resting position, or until the locking spring tabs 20 are close to an extended position (e.g., as close to an extended position as possible owing to the distance between the flange 14 and the cam surface 20b). The outward bias of the locking spring tab 20 in a direction toward the original outward extending (e.g., resting) position of the tab 20 can result in a biasing force being exerted by the end portion of the tab 20 on the outer surface 214a of the wall 214.

One of ordinary skill in the art will recognize that other configurations and arrangements of the locking spring tabs 20 and/or curved and/or angled cam surfaces 20a and 20b are contemplated, such as one or more tabs 20 being hinged at an angle other than vertical or horizontal, one or more tabs 20 having different front profiles, side profiles, cam profiles, etc.

According to the examples described herein, an exemplary embodiment of the invention can include a push-in catalyst assembly (e.g., 10) for a home cooking appliance (e.g., 100), the push-in catalyst assembly (e.g., 10) comprising a body (e.g., 12) configured to support a catalytic material, the body (e.g., 12) having a distal end and a proximal end, a flange (e.g., 14) extending from a region of the proximal end of the body (e.g., 12) and configured to abut an inner surface (e.g., 214b) of a wall (e.g., 214) of the cooking compartment (e.g., 220), a plurality of locking spring tabs (e.g., 20) extending outward from the body (e.g., 12), the plurality of locking spring tabs (e.g., 20) having an end portion (e.g., 20b) spaced from the flange by a predetermined distance, wherein the flange (e.g., 14) and the end portion (e.g., 20b) of each of the plurality of locking spring tabs (e.g., 20) are configured to secure the wall (e.g., 214) of the cooking compartment (e.g., 200) therebetween without a fastener.

Another exemplary embodiment of the invention can include a household appliance (e.g., 100) comprising a housing (e.g., 212) having a cooking compartment (e.g., 200), the cooking compartment (e.g., 200) defined at least in part by a wall (e.g., 214), the wall (e.g., 214) having an inner surface (e.g., 214b) facing the cooking compartment (e.g., 200), an outer surface (e.g., 214a) facing outside the cooking compartment (e.g., 200), and an opening (e.g., 215), and a push-in catalyst assembly (e.g., 10) disposed in the opening (e.g., 215) and secured to assembly (e.g., 10) includes a body (e.g., 12) configured to support a catalytic material, the body (e.g., 12) having a distal end and a proximal end, wherein the body (e.g., 12) extends through the opening (e.g., 215) in the wall (e.g., 214) such that the distal end is disposed on an outer side of the wall (e.g., 214) with respect to the cooking compartment (e.g., 200), a flange (e.g., 14) extending from a region of the proximal end of the body (e.g., 12) and configured to abut the inner surface (e.g., 214b) of the wall (e.g., 214) facing the cooking compartment (e.g., 200), the flange (e.g., 14) having a diameter greater than a diameter of the opening (e.g., 215), and a plurality of locking spring tabs (e.g., 20) extending outward from the body (e.g., 12) and disposed between the flange (e.g., 14) and the proximal end of the body (e.g., 12), wherein the plurality of locking spring tabs (e.g., 20) is disposed on the outer side of the wall (e.g., 214) with respect to the cooking compartment (e.g., 200), wherein each of the plurality of locking spring tabs (e.g., 20) includes an end portion (e.g., 20b) spaced from the flange (e.g., 14) by a predetermined distance, and wherein the flange (e.g., 14) and the end portion (e.g., 20b) of each of the plurality of locking spring tabs (e.g., 20) are configured to secure the wall (e.g., 214) of the cooking compartment (e.g., 200) therebetween without a fastener.

Yet another exemplary embodiment of the invention can include a household appliance (e.g., 100) comprising a housing (e.g., 212) having a cooking compartment (e.g., 200), the cooking compartment (e.g., 200) defined at least in part by a wall (e.g., 214), the wall (e.g., 214) having an inner surface (e.g., 214b) facing the cooking compartment (e.g., 200), an outer surface (e.g., 214a) facing outside the cooking compartment (e.g., 200), and an opening (e.g., 215), and a push-in catalyst assembly (e.g., 10) disposed in the opening (e.g., 215) and secured to assembly (e.g., 10) includes a body (e.g., 12) configured to support a catalytic material, the body (e.g., 12) having a distal end and a proximal end, wherein the body (e.g., 12) extends through the opening (e.g., 215) in the wall (e.g., 214) such that the distal end is disposed on an outer side of the wall (e.g., 214) with respect to the cooking compartment (e.g., 200), a flange (e.g., 14) extending from a region of the proximal end of the body (e.g., 12) and configured to abut the inner surface (e.g., 214b) of the wall (e.g., 214) facing the cooking compartment (e.g., 200), the flange (e.g., 14) having a diameter greater than a diameter of the opening (e.g., 215), and locking means (e.g., 20) for securing the flange (e.g., 14) against the wall (e.g., 214) of the cooking compartment (e.g., 200) without a fastener.

The present invention has been described herein in terms of several preferred embodiments. However, modifications and additions to these embodiments will become apparent to those of ordinary skill in the art upon a reading of the foregoing description. It is intended that all such modifications and additions comprise a part of the present invention to the extent that they fall within the scope of the several claims appended hereto.

What is claimed is:

1. A push-in catalyst assembly for a home cooking appliance, the push-in catalyst assembly comprising:
a body configured to support a catalytic material, the body having a distal end and a proximal end;
a flange extending from a region of the proximal end of the body and configured to abut an inner surface of a wall of the cooking compartment; and
a plurality of locking spring tabs extending outward from the body, the plurality of locking spring tabs having an end portion spaced from the flange by a predetermined distance,
wherein the flange and the end portion of each of the plurality of locking spring tabs are configured to secure the wall of the cooking compartment therebetween without a fastener.

2. The push-in catalyst assembly of claim 1, wherein each of the plurality of locking spring tabs are biased to extend outward from an outermost perimeter of the body.

3. The push-in catalyst assembly of claim 1, wherein a locking spring tab of the plurality of locking spring tabs includes a flap projecting from the body and biased to extend outward from an outermost perimeter of the body.

4. The push-in catalyst assembly of claim 1, wherein each of the plurality of locking spring tabs are configured to flex in an inward direction with respect to the body and to resist flexing in an outward direction beyond a predetermined biased position with respect to the body.

5. The push-in catalyst assembly of claim 1, wherein the plurality of locking spring tabs are spaced around a perimeter of the body.

6. The push-in catalyst assembly of claim 5, wherein the plurality of locking spring tabs are equally spaced around the perimeter of the body.

7. The push-in catalyst assembly of claim 1, wherein a locking spring tab of the plurality of locking spring tabs has a fixed end coupled to the body and a free end extending from the body.

8. The push-in catalyst assembly of claim 1, wherein a locking spring tab of the plurality of locking spring tabs has a triangular profile.

9. The push-in catalyst assembly of claim 1, wherein a locking spring tab of the plurality of locking spring tabs has a U-shaped profile.

10. The push-in catalyst assembly of claim 1, wherein a locking spring tab of the plurality of locking spring tabs has a square-shaped profile.

11. The push-in catalyst assembly of claim 1, wherein the end portion of the locking spring tab includes a cam surface facing the flange, wherein a part of the cam surface is spaced from the flange by the predetermined distance.

12. The push-in catalyst assembly of claim 10, wherein an edge of the end portion which faces in an outward direction with respect to the body includes at least one of an angled profile and a curved profile.

13. The push-in catalyst assembly of claim 1, wherein the flange has a fixed position with respect to the body.

14. The push-in catalyst assembly of claim 1, wherein the predetermined distance that the end portion is spaced from the flange is configured to be substantially equal to a thickness of the wall of the cooking compartment.

15. A household appliance comprising:
a housing having a cooking compartment, the cooking compartment defined at least in part by a wall, the wall having an inner surface facing the cooking compartment, an outer surface facing outside the cooking compartment, and an opening; and
a push-in catalyst assembly disposed in the opening and secured to the wall of the cooking compartment,
wherein the push-in catalyst assembly includes:
a body configured to support a catalytic material, the body having a distal end and a proximal end, wherein the body extends through the opening in the wall such that the distal end is disposed on an outer side of the wall with respect to the cooking compartment;
a flange extending from a region of the proximal end of the body and configured to abut the inner surface of the wall facing the cooking compartment, the flange having a diameter greater than a diameter of the opening; and
a plurality of locking spring tabs extending outward from the body and disposed between the flange and the proximal end of the body, wherein the plurality of locking spring tabs is disposed on the outer side of the wall with respect to the cooking compartment,
wherein each of the plurality of locking spring tabs includes an end portion spaced from the flange by a predetermined distance, and
wherein the flange and the end portion of each of the plurality of locking spring tabs are configured to secure the wall of the cooking compartment therebetween without a fastener.

16. The household appliance of claim 15, wherein each of the plurality of locking spring tabs are biased to extend radially outward from an outermost perimeter of the body such that the plurality of locking spring tabs extend beyond the diameter of the opening.

17. The household appliance of claim 15, wherein each of the plurality of locking spring tabs are configured to flex in an inward direction with respect to the body of the push-in catalyst assembly when the push-in catalyst assembly is pushed into the opening such that the plurality of locking spring tabs are capable of passing through the opening along with the body of the push-in catalyst assembly.

18. The household appliance of claim 15, wherein the plurality of locking spring tabs restricts a removal of the push-in catalyst assembly from the opening when the push-in catalyst assembly is in an installed position within the opening.

19. The household appliance of claim 15, wherein a locking spring tab of the plurality of locking spring tabs has a fixed end coupled to the body and a free end extending from the body.

20. The household appliance of claim 19, wherein a part of the free end of the locking spring tab of the plurality of locking spring tabs abuts the outer surface of the wall of the cooking compartment when the push-in catalyst assembly is in an installed position within the opening.

21. The household appliance of claim 20, wherein the part of the free end of the locking spring tab exerts a force on the outer surface of the wall of the cooking compartment when the push-in catalyst assembly is in an installed position within the opening to thereby draw the flange in a direction toward the inner surface of the wall of the cooking compartment.

22. The household appliance of claim 21, wherein the flange abuts an interior surface of the wall of the cooking compartment when the push-in catalyst assembly is in the installed position within the opening.

23. The household appliance of claim 19, wherein the free end of the locking spring tab includes a cam surface facing the flange, and
wherein a part of the cam surface is spaced from the flange by the predetermined distance.

24. The household appliance of claim 23, wherein an edge of the free end of the locking spring tab which faces in an outward direction with respect to the body includes at least one of an angled profile and a curved profile.

25. A household appliance comprising:
a housing having a cooking compartment, the cooking compartment defined at least in part by a wall, the wall having an inner surface facing the cooking compartment, an outer surface facing outside the cooking compartment, and an opening; and
a push-in catalyst assembly disposed in the opening and secured to the wall of the cooking compartment,
wherein the push-in catalyst assembly includes:
a body configured to support a catalytic material, the body having a distal end and a proximal end, wherein the body extends through the opening in the wall such that the distal end is disposed on an outer side of the wall with respect to the cooking compartment;
a flange extending from a region of the proximal end of the body and configured to abut the inner surface of the wall facing the cooking compartment, the flange having a diameter greater than a diameter of the opening; and
locking means for securing and tightening the flange against the wall of the cooking compartment without a fastener.
